(19) United States
(12) Patent Application Publication
(10) Pub. No.: US 2024/0378732 A1
(43) Pub. Date: Nov. 14, 2024

(54) OBJECT TRACKING METHOD AND APPARATUS IN EXTENDED REALITY ENVIRONMENT, DEVICE AND MEDIUM

(71) Applicant: BEIJING ZITIAO NETWORK TECHNOLOGY CO., LTD., Beijing (CN)

(72) Inventor: Yixin CHEN, Beijing (CN)

(21) Appl. No.: 18/690,192

(22) PCT Filed: Aug. 23, 2022
(86) PCT No.: PCT/CN2022/114145

§ 371 Date: Mar. 7, 2024

(30) Foreign Application Priority Data
Sep. 7, 2021 (CN) 202111043621.4

(51) Int. Cl. G06T 7/246; G06F 3/01; G06T 7/73; G06T 13/20; G06T 15/06; G06T 15/30

(52) U.S. Cl. CPC G06T 7/246; G06F 3/011; G06T 7/73; G06T 13/20; G06T 15/06; G06T 15/30; G06T 2210/21

(57) ABSTRACT

The present disclosure provides an object tracking method and apparatus in an extended reality environment, a device, a medium and a product. The method includes: a terminal determining whether an object in an extended reality environment is within a screen display range, and when the object is not within the screen display range of the terminal, prompting the user as to the orientation of the object, so that the user adjusts the pose of the terminal according to the prompt, so as to cause the object to appear in the screen display range of the terminal, thereby achieving the tracking of a movable object.

### CROSS-REFERENCE TO RELATED APPLICATION

This application claims the priority of Chinese patent application No. 202111043621.4, entitled “object tracking method and apparatus in extended reality environment, device and medium” filed in the Chinese Patent Office on Sep. 7, 2021, which is incorporated herein by reference in its entirety.

### TECHNICAL FIELD

Embodiments of the present disclosure relate to the technical field of computers, and in particular to an object tracking method and system in an extended reality environment, a device, a computer-readable storage medium and a computer program product.

### BACKGROUND

With the continuous development of computer technology, a new interaction mode, namely extended reality (XR), came into being. Extended reality refers to a real and virtual environment capable of achieving human-computer interaction generated by the computer technology and a wearable device. The extended reality includes augmented reality (AR), virtual reality (VR), mixed reality (MR) and other forms.

At present, many applications, such as live broadcast applications and game applications, use the XR interaction mode. By taking a live broadcast application using the AR interaction mode as an example, a user may broadcast live in a room, and the live broadcast application may display movable objects (for example, virtual objects such as an electronic red envelope and an electronic mascot) in a room environment in an overlapped manner.

In order to improve interactivity, a user may track the above-mentioned movable objects for interaction. However, the efficiency of tracking the above-mentioned movable objects by the user according to own experience is relatively low, and the user-friendliness is low, which affects the interaction experience.

### SUMMARY

An objective of the present disclosure is to provide an object tracking method and apparatus in an extended reality environment, a device, a computer-readable storage medium and a computer program product, which can reduce the operation difficulty of the user in tracking objects in the extended reality environment and improve the user-friendliness and the interaction experience of the user.

In a first aspect, the present disclosure provides an object tracking method in an extended reality environment, being applied to a terminal, the method includes:
determining whether an object in the extended reality environment appears within a screen display range of the terminal;
prompting a user of an orientation of the object when the object does not appear within the screen display range of the terminal; and
adjusting a posture of the terminal to make the object to appear within the screen display range of the terminal, in response to an adjustment operation triggered by the user according to the orientation of the object, which is prompted.

In a second aspect, the present disclosure provides an object tracking apparatus in an extended reality environment, the apparatus includes:
a determination module, configured to determine whether an object in the extended reality environment appears within a screen display range of the terminal;
a prompting module, configured to prompt a user of an orientation of the object when the object does not appear within the screen display range of the terminal; and
an adjustment module, configured to adjust a posture of the terminal to make the object to appear within the screen display range of the terminal, in response to an adjustment operation triggered by the user according to the orientation of the object, which is prompted.

In a third aspect, the present disclosure provides an electronic device including:
a storage apparatus, having stored thereon a computer program;
a processing apparatus, configured to execute the computer program in the storage apparatus to implement steps of the method according to any one of the first aspect or the second aspect.

In a fourth aspect, the present disclosure provides a computer-readable storage medium, having stored thereon a computer program, the computer program, when executed by a processing apparatus, implementing steps of the method according to any one of the first aspect or the second aspect.

In a fourth aspect, the present disclosure provides a computer program product, which, when run on a computer, causes the computer to perform the method according to any one of the first aspect or the second aspect.

As can be seen from the above technical solution, the present disclosure has at least the following advantages.

Through the above-mentioned technical solution, the terminal determine whether an object in the extended reality environment is within a screen display range, and in a case that the object is not within the screen display range of the terminal, a user is prompted of an orientation of the object, so that the user adjusts a posture of the terminal according to the prompt to make the object to appear within the screen display range of the terminal, thereby realizing the tracking for a movable object. In this way, by prompting the user of the orientation of the object to help the user track the movable object, the user may track the object according to the prompt without relying on experience, so that the operation difficulty of the user in tracking the object in the extended reality environment is reduced, and the user-friendliness and the interaction experience of the user are improved.

Other features and advantages of the present disclosure will be described in detail in the following detailed description.

### BRIEF DESCRIPTION OF DRAWINGS

In order to explain technical methods of embodiments of the present disclosure more clearly, the drawings needed in the embodiments will be briefly introduced below.

FIG. 1 is a system architecture diagram of an object tracking system in an extended reality environment provided by an embodiment of the present disclosure;

FIG. 2 is a flowchart of an object tracking method in an extended reality environment provided by an embodiment of the present disclosure;

FIG. 3 is a schematic diagram of a perspective projection provided by an embodiment of the present disclosure;

FIG. 4 is a schematic diagram of coordinate axes of a clipping coordinate system provided by an embodiment of the present disclosure;

FIG. 5 is a schematic diagram of a part of an object in a display interface provided by an embodiment of the present disclosure;

FIG. 6 is a schematic diagram of a part of another object in a display interface provided by an embodiment of the present disclosure;

FIG. 7 is a schematic diagram of coordinate axes of a view coordinate system provided by an embodiment of the present disclosure;

FIG. 8 is a schematic diagram of angle acquisition of an object provided by an embodiment of the present disclosure;

FIG. 9 is a schematic diagram of a display interface prompt provided by an embodiment of the present disclosure;

FIG. 10 is a schematic diagram of another display interface prompt provided by an embodiment of the present disclosure;

FIG. 11 is a schematic diagram of yet another display interface prompt provided by an embodiment of the present disclosure;

FIG. 12 is a schematic diagram of a z axis of a coordinate system provided by an embodiment of the present disclosure;

FIG. 13 is a schematic diagram of a display interface for object tracking in an extended reality environment provided by an embodiment of the present disclosure;

FIG. 14 is a schematic diagram of an object tracking apparatus in an extended reality environment provided by an embodiment of the present disclosure; and

FIG. 15 is a schematic structural diagram of an electronic device provided by an embodiment of the present disclosure.

### DETAILED DESCRIPTION

The terms “first” and “second” in the embodiments of the present disclosure are used for descriptive purposes only and are not to be construed as indicating or implying relative importance or to implicitly indicate the number of technical features indicated. Thus, a feature defined as “first” or “second” may explicitly or implicitly include one or more of the features.

Some technical terms referred to in the embodiments of the present disclosure will be first described.

Extended reality (XR) may provide a virtual environment for human-computer interaction, bringing an experiencer a “sense of immersion” of seamless transition between a virtual world and a real world. In general, XR includes augmented reality (AR), virtual reality (VR) and mixed reality (MR) and other forms. AR refers to the addition of virtual content to a real space and the mapping of virtual information (such as articles, pictures, videos, sounds) to a real environment. VR refers to the use of a computer to simulate a three-dimensional space, and to simulate a sense of immersion and a sense of presence for a user through his senses, so that the user may experience a virtual simulated world. XR may be regarded as a combination of AR and VR, which can merge the real world and the virtual world to create a new visual environment.

An XR interaction mode is applied to a wide variety of games and live broadcasts. Here, by taking AR in the XR interaction mode as an example, the application of XR in games and live broadcasts is introduced. In a game, it is set that the user may find props in an AR environment within a fixed period of time, and prop rewards are generated according to the props found by the user during this period of time. The prop rewards may be props that may be used in other games. In general, the user searches for virtual objects in the real world through a screen according to the experience or own memory, but this search for the virtual objects is highly dependent on the user experience, and the search efficiency of the user for the virtual objects and the user-friendliness are low, which affects the acceptance degree of the user to this mode.

With that in mind, embodiments of the present disclosure provide an object tracking method in an extended reality environment. The method may be executed by a terminal. Specifically, the terminal determines whether an object in the augmented reality appears within the screen display range, when the object does not appear within the screen display range, the terminal prompts the user of an orientation of the object, the user may adjust the terminal according to the prompt, and then a posture of the terminal is adjusted according to an adjustment operation for the terminal by the user, to make the object to appear within the screen display range, thereby realizing the tracking for the object in the extended reality environment.

According to the method, when the object does not appear within the screen display range of the terminal, by prompting the user of the orientation of the object, the user can obtain position information of the object according to the prompt, so that the user can find the object purposefully, the difficulty of the user operation is reduced and the degree of participation of the user is improved; and by prompting the user of the orientation of the object, the user may adjust the posture of the terminal to place the object in the screen display range, and thus the user is assisted in tracking the object.

In order to make the technical solution of the present disclosure clearer and easier to understand, a system architecture of the object tracking method in the extended reality environment provided by embodiments of the present disclosure is introduced below with the attached drawings.

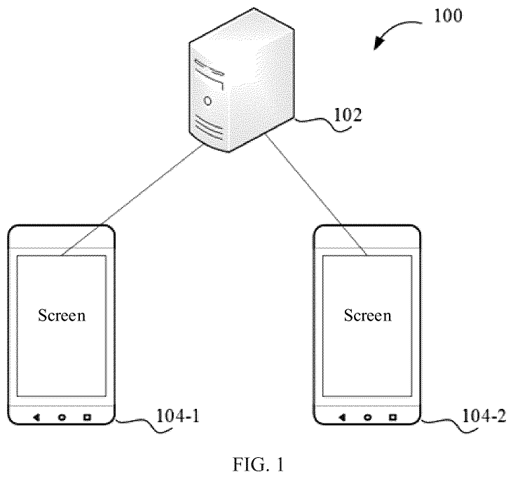

With reference to an architectural schematic diagram of an object tracking system in an extended reality environment shown in FIG. 1, an object tracking system 100 in the extended reality environment includes a server 102 and a terminal 104. The server 102 may be a cloud server, such as a central server in a central cloud computing cluster or an edge server in an edge cloud computing cluster. Certainly, the server 102 may also be a server in a local data center. The local data center refers to a data center directly controlled by the user. The terminal 104 includes, but is not limited to, a smartphone, a tablet computer, a notebook computer, a personal digital assistant (PDA) or a smart wearable device, etc. It is noted that the object tracking system 100 in the extended reality environment includes one or more terminals 104, and FIG. 1 illustrates an example in which the object tracking system 100 in the extended reality environment includes a plurality of terminals 104.

Specifically, the terminal judges whether the object appears within the screen display range of the terminal based on a motion trajectory of the object stored in the server. For example, the server stores a motion trajectory of a virtual monster, and the terminal determines whether the virtual monster is within the screen display range of the terminal based on the motion trajectory of the virtual monster as well as a position of the terminal and a screen size of the terminal. When the object does not appear within the screen display range of the terminal, the user is prompted of an orientation of the object, so that the user is prompted to adjust the posture of the terminal. Then the terminal adjusts the posture of the terminal according to the adjustment operation of the user, to make the object to appear within the screen display range of the terminal. When the object moves, the screen of the terminal constantly adjusts the screen display range of the terminal according to the movement of the object and the adjustment on the posture of the terminal by the user, until the object appears within the screen display range of the terminal. In this way, by prompting the user of the orientation of the object, the user may track the object.

The object tracking system 100 for executing the object tracking method in XR has been described above. Next, the object tracking method in AR provided by the embodiments of the present disclosure will be described in detail from the perspective of the terminal 104.

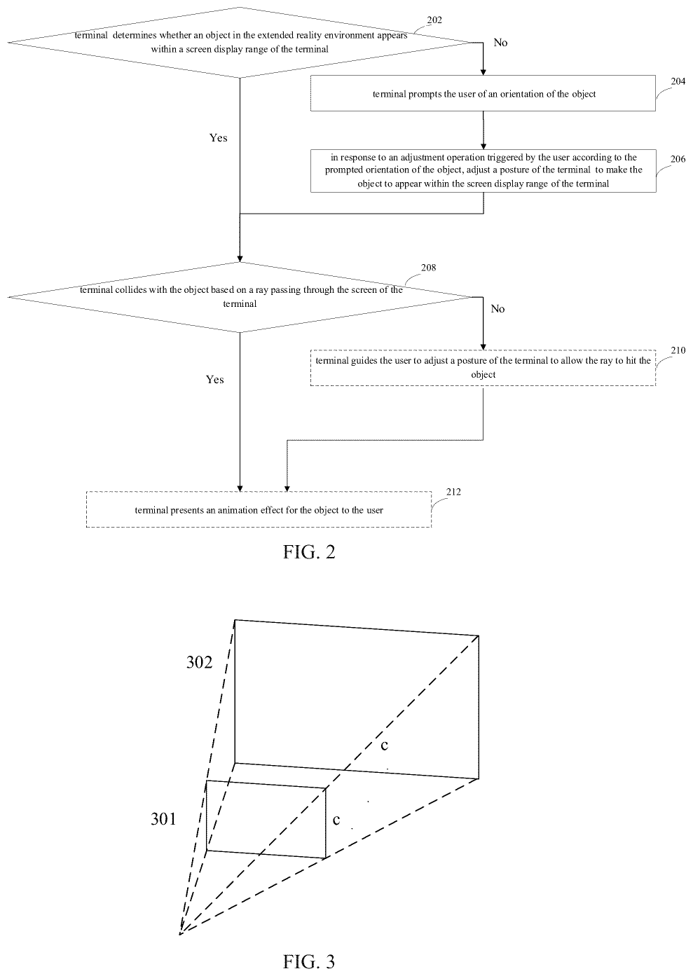

With reference to an interaction flowchart of the object tracking method in AR shown in FIG. 2, the method includes the following steps.

S202: the terminal 104 determines whether an object in the extended reality environment appears within a screen display range of the terminal 104.

The object in AR may be a virtual object, such as an electronic red envelope, an electronic mascot, an electronic prop, etc. The user may acquire corresponding red envelopes, mascots, game props, etc. by finding the virtual object.

In some possible implementations, an application scene of AR may be a mini-game triggered by the user, the mini-game may appear according to the trigger of the user, electronic props acquired by the user in AR may be converted into game props to be used in other games, so as to urge the user to find as many electronic props as possible in AR.

The virtual object may be a dynamic object, and the motion trajectory of the virtual object is pre-stored in a server corresponding to the terminal 104. The objects in the AR may be multiple objects, and the terminal 104 may respectively determine whether each object appears within the screen display range of the terminal 104. In order to improve the interestingness of interaction, motion trajectories corresponding the multiple objects respectively may be stored in the server corresponding to the terminal, and the corresponding number of objects are randomly selected according to requirements in the mini-game every time, so that a situation that the motion trajectory of each object is repeated to influence the user experience is avoided.

In general, the motion trajectory of the virtual object is a motion trajectory in a world coordinate system, thus the motion trajectory of the virtual object may be transformed from the world coordinate system to a clipping coordinate system of a camera of the terminal 104 through view-projection (VP) matrix transformation.

The VP matrix includes a view (V) matrix and a projection (P) matrix. The view matrix is used for transforming coordinates of an article in the world coordinate system to coordinates in a view coordinate system. The view coordinate system refers to a coordinate system centered on the camera, also called a camera coordinate system. The view matrix may allow an origin of the camera to be located at an origin of the coordinate system in the world coordinate system and allow the coordinate axes of the camera coordinate system to be coincided with coordinate axes of the world coordinate system, by acquiring a position of the camera and translating the whole camera coordinate system. Since the world coordinate system is a left-handed coordinate system and the camera coordinate system is a right-handed coordinate system, it is necessary to negate a z axis component in a transformation matrix obtained by calculation, and the view matrix can be obtained in this way.

The projection matrix is used for projecting an article from the camera coordinate system to the clipping coordinate system, with the purpose of judging whether a vertex is visible. In general, the projection matrix includes orthogonal projection and perspective projection. Based on the principle that everything looks small in the distance and big on the contrary in imaging, a vision cone space is projected from the camera in perspective projection, and a cone space may be clipped in the vision cone space through a near clipping plane 301 and a far clipping plane 302. The cone space is a visible space of perspective projection, as shown in FIG. 3.

The terminal 104 may determine whether the article appears within the screen display range of the terminal 104 according to coordinates of the article in the clipping coordinate system. Specifically, the terminal 104 may acquire the coordinates of the article in the camera coordinate system, and acquire coordinates of the article in the clipping coordinate system according to the coordinates in the camera coordinate system and a P transformation matrix from the camera coordinate system to the clipping coordinate system. Further, the terminal 104 may acquire the coordinates of the article in the world coordinate system, and then acquire the coordinates of the article in the camera coordinate system according to the coordinates of the article in the world coordinate system and a V transformation matrix from the world coordinate system to the view coordinate system. Therefore, the coordinates of the article can be transformed into the coordinates in the clipping coordinate system according to the coordinates of the article in the camera coordinate system and the P transformation matrix from the camera coordinate system to the clipping coordinate system.

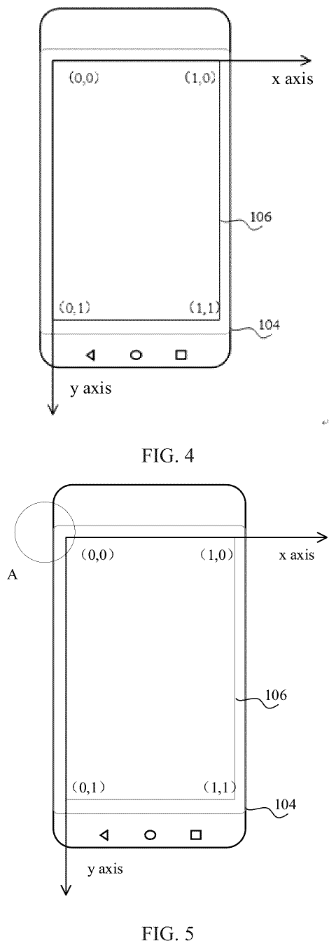

In this way, the motion trajectory of the object in the world coordinate system may be transformed into the motion trajectory of the object in the clipping coordinate system based on the VP matrix, and the coordinates of the object in the clipping coordinate system are consistent with screen coordinates. In some possible implementations, as shown in FIG. 4, an upper left of a screen display interface 106 may be set as a coordinate origin, a rightward direction of an upper edge of the display interface 106 may be set as a positive direction of an x axis and a downward direction of a left edge of the display interface 106 may be set as a positive direction of a y axis. Further, a length from a leftmost end to a rightmost end of the display interface 106 may be defined as one unit length in the x axis, and a length from a topmost end to a bottommost end of the display interface 106 may be defined as one unit length in the y axis, then coordinates of an upper left corner, an upper right corner, a lower left corner and a lower right corner of the display interface 106 are (0, 0), (1, 0), (0, 1) and (1, 1) respectively. An abscissa of any point in the display interface 106 of the screen is between an interval [0,1], and an ordinate thereof is also between the interval [0,1]. In this way, whether the object is within the screen display interface 106 may be determined by whether the coordinates of the object transformed to the clipping coordinate system satisfy that both the abscissa and the ordinate are between the interval [0,1].

In some possible implementations, the server may abstract the object as a central point of the object and store it, and the pre-stored motion trajectory of the object may be the motion trajectory of points. In general, the object may be an article, and the article has a volume, thus there may be a situation that a central point of the article is outside the display interface 106, but other parts of the article are inside the display interface 106, as shown in FIG. 5. Therefore, when judging whether the object is in the display interface 106, an error range may be determined according to a size of the object. For example, when the object is a sphere A with a radius of 0.1, it may be considered that the object A appears within the screen display interface 106 of the terminal 104 when the abscissa of the object A is within the range of [-0.1,1.1].

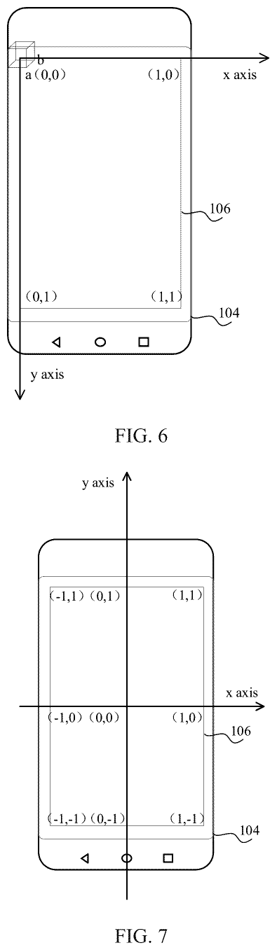

In other possible implementations, the server may store the motion trajectory of each point of the object, and when any one of points of the object is within the abscissa and ordinate range, it is considered that the object appears within the screen display interface 106 of the terminal 104. Further, in order to save the storage space of the server and the calculation amount during coordinate transformation, motion trajectories of vertexes of the object may be selected, and when any one of vertexes of the object is within the above-mentioned abscissa and ordinate range, it is considered that the object appears within the screen display interface 106. As shown in FIG. 6, both a point a and a point b of an object B are in the display interface 106 of the screen, thus the object B is located in the display interface 106 of the screen.

When the object in AR does not appear within the screen display range of the terminal 104, S204 is executed; in response to the object in AR appearing within the screen display range of the terminal 104, S208 is executed.

S204: the terminal prompts the user of an orientation of the object.

The terminal may prompt the user of the orientation of the object in various ways. For example, the user may be prompted of the orientation of the object through an icon in the screen, or through voice, or through both the icon and voice at the same time.

Since there may be a situation where multiple objects are outside the screen display range of the terminal 104 and the reminding of the object position by voice may cause a conflict, the user may be reminded of the orientations of the objects in turn according to the distances between the objects and the screen display interface 106. Since the user may immediately change the posture of the terminal 104 according to the prompt and a change of the screen display interface 106 is caused, the voice reminder may only remind the user of the orientation of the nearest object at present. In some possible implementations, a moving trend of the terminal 104 may also be considered. For example, the terminal 104 is moving to the left, so that the user may be reminded of the orientation of the object located on the left, or the orientation of the object located above or below that the terminal 104 ignores when moving to the left.

The icons on the screen may prompt as to the orientations of multiple objects at the same time. Considering that multiple icon prompts may affect the display of objects on the screen, an upper limit of prompt icons for objects on the screen is set; for example, the upper limit of the prompt icons may be set to 5, and only position information of 5 objects can be prompted in the display interface at most.

Specifically, since it has been judged by S202 that the object is not within the screen display range, the coordinates of the object may be transformed from the world coordinate system to the camera coordinate system (the view coordinate system), that is, only view (V) matrix transformation is needed, and transformation to the clipping coordinate system is not needed. In S202, the coordinates of the object are transformed into the clipping coordinate system because of the principle that everything looks small in the distance and big on the contrary. As shown in FIG. 3, the screen display ranges are different depending on the distance. For example, a point c is not within the display range when the distance is close, and is within the display range when the distance is far. However, in S204, it has been determined that the object does not appear within the screen display range of the terminal 104, thus the orientation of the object may be obtained after being transformed into the camera coordinate system. The orientation of the object may be represented by an azimuth angle. Specifically, a direction vector of the object may be determined according to the coordinates of the object in the camera coordinate system, and the azimuth angle of the object may be acquired according to the direction.

In some possible implementations, the object may be transformed from the world coordinate system to the camera coordinate system according to a first transformation matrix from the camera coordinate system to the world coordinate system. Specifically, an inverse matrix of the first transformation matrix is the view matrix (V matrix) from the world coordinate system to the camera coordinate system, thus the view matrix may be acquired according to the inverse matrix of the first transformation matrix from the camera coordinate system to the world coordinate system, and the object may be transformed from the world coordinate system to the camera coordinate system through the view matrix.

In S204, as shown in FIG. 7, a central point of the screen may be set as an origin of a coordinate axis, a right line is recorded as a positive half axis of an x axis, a horizontal half axis of a right edge of the screen is recorded as 1, an upper line is recorded as a positive half axis of a y axis, ordinates of the upper edge of the screen are all 1, and a distance between the object and the camera on the axes may be uniformly recorded as 0, that is, only up, down, left and right information of the object relative to the origin is considered. A position of the object in the camera coordinate system is determined, and the direction of the point is a direction vector of the origin pointing to the object. When information of multiple points of an object is stored in the server, the direction of the point is a direction vector of the origin pointing to the central point of the object.

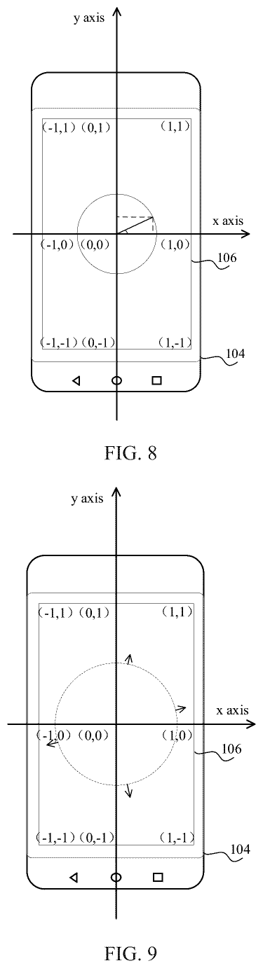

In some possible implementations, if the screen wants to display an arrow pointing to the object, the direction vector needs to be converted into an angle, as shown in FIG. 8, and the angle may be acquired by an arctan function. The position of the object may be located in any quadrant in FIG. 8 and arctan function values of the first quadrant and the third quadrant are the same and arctan function values of the second quadrant and the fourth quadrant are the same, thus it is necessary to judge the specific quadrant of the object according to the coordinates of the object. Similarly, the specific quadrant may be determined according to the coordinates of the object, and then a specific angle value may be acquired. The terminal 104 may render a head up display (HUD) cue at a position corresponding to the azimuth angle in the screen according to the determined azimuth angle of the object, where the HUD cue includes the azimuth angle of this object, which is used for prompting the user of the azimuth angle of the object.

Voice may prompt the user of the orientation of the object according to the determined quadrant and angle of the object. For example, in response to determining that the object is located in the first quadrant through the above steps and an included angle between the object and the x axis is 30 degrees, it will prompt: “The target (object) is located 30 degrees above the right side” and so on.

The display interface of the screen prompts as to the position of the direction according to the angle value acquired in the above steps. In order to prevent the prompt icons from blocking the object, a radius may be set, and the screen of the terminal 104 prompts as to the position of the object with this radius, and as shown in FIG. 9 all the prompt icons are outside the circle.

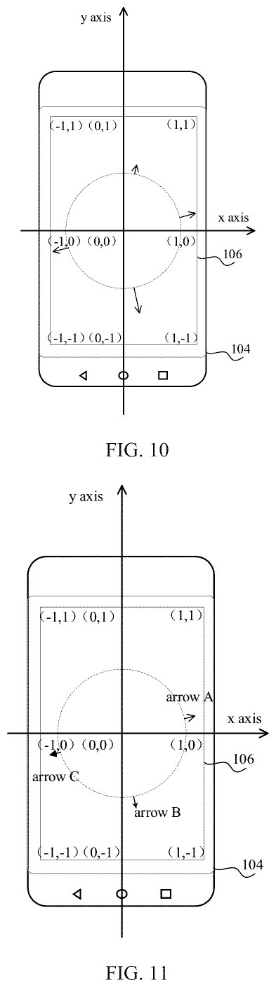

Further, the distance between the object and the origin of the screen may also be considered. For example, a length of the arrow may be determined in equal proportions of the distance. As shown in FIG. 10, a longer arrow indicates that the object is far away, and a shorter arrow indicates that the object is close. The objects may also be classified into various categories according to the distance. As shown in FIG. 11, when the distance is less than or equal to 2, an arrow A is used to prompt; when the distance is greater than 2 and less than or equal to 3, an arrow B is used to prompt; and when the distance is greater than 3, an arrow C is used to prompt.

Voice may also prompt as to the distance of the object from the origin of the screen, for example: “The target (object) is located 30 degrees above the right side, and the distance is close”.

In this way, by prompting the user of accurate orientation information of the object, when the object does not appear within the screen display range of the terminal 104, the user can find the object according to the prompt to place the object within the screen display range.

S206: in response to an adjustment operation triggered by the user according to the prompted orientation of the object, adjust a posture of the terminal 104 to make the object to appear within the screen display range of the terminal 104.

The user triggers the adjustment operation according to the reminder of the orientation of the object sent by the terminal 104, and the posture of the terminal 104 is adjusted according to the adjustment operation of the user, to make the object to appear within the screen display range of the terminal 104. Specifically, the user may move the terminal 104 to the left, the terminal 104 to the right, the terminal 104 to the upward, the terminal 104 to the downward, and change an included angle between the terminal 104 and the ground according to the prompted orientation of the object. Correspondingly, the posture of the terminal 104 is adjusted according to the adjustment operation of the user, to make the object to appear within the screen display range of the terminal 104.

In this way, the user can be assisted in tracking the object by the prompt of the object position. When the terminal determines that the object in the AR does not appear within the screen display range, it prompts the user of the orientation of the object according to the stored position of the object, so that a situation that the user spends a lot of time and energy in remembering the orientation of the object is avoided, and the user can adjust the posture of the terminal according to the prompt to allow the object to appear within the screen display range of the terminal, thereby reducing the difficulty of the user in tracking the object in the AR, and improving the user-friendliness and the interaction experience.

In some possible implementations, the present disclosure also includes subsequent operations in response to the object appearing within the screen display range of the terminal 104, and thus further includes the following steps.

S208: the terminal 104 collides with the object based on a ray passing through the screen of the terminal 104.

Based on the prompt of the orientation of the object in S204 and S206 and in response to the adjustment operation of the user, the posture of the terminal 104 may be adjusted, so that the object may appear within the screen display range of the terminal 104. In response to the object appearing within the screen display range of the terminal 104, the terminal 104 may collide with the object through the ray, for example, the terminal 104 may collide with the object using the ray emitted from a center of the screen display range.

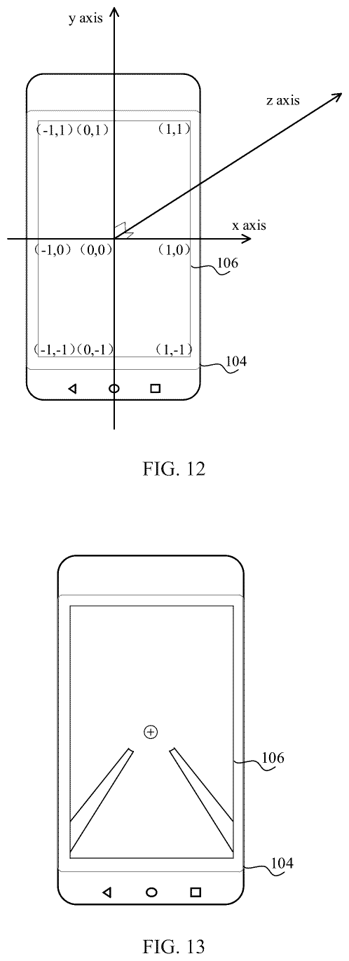

Ray collision refers to emitting a ray from a point in the screen display range, and the ray is perpendicular to the screen and points to a shooting direction. In response to the object appearing within a corresponding region of the point in the screen display range, the ray may collide with the object. For example, the terminal 104 may set the center of the screen as a preset point, and in response to the object being located in the center of the screen, the ray generated based on the preset point may hit the object, presenting an animation effect for the object to the user. As shown in FIG. 12, the ray is emitted from the center of the screen, the direction is perpendicular to a plane where the screen is located, and the ray points to the shooting direction. When the ray passes through the object, it is considered that the object touches the ray.

Position coordinates of the screen central point in a rendering coordinate system may be obtained by acquiring the screen resolution and then multiplying it by 0.5, and then the ray may be constructed according to the position coordinates of the screen central point. Since the camera in the terminal 104 has rotation parameters and position parameters, an orientation of the camera may be acquired according to the rotation parameters and position parameters of the camera, and a direction of the ray is consistent with the orientation. Then the object is judged by the ray collision, and the server corresponding to the terminal 104 may judge whether the object appears within a central region of the screen display range according to the stored motion trajectory of the object.

Specifically, ray collision may be realized by setting a long line segment to simulate a ray. For example, a line segment with a length of 1000 meters from a preset point may be set to simulate the ray to achieve ray collision, and a ray collision test function (ray Test) may be used to judge whether the ray passes through the object. In some possible implementations, ray collision can only identify the object closest to the screen, so that there may be a situation where only the object closest to the screen can be identified when multiple objects are in the center of the screen at the same time. In this case, it may be considered that other objects located in the center of the screen except the nearest object are blocked by obstacles instead of being considered to be located in the center of the screen, and the user may allow other objects to be in the center of the screen without blocking by continuously adjusting the posture of the terminal 104.

In response to the ray not hitting the object, S210 is executed, and the terminal 104 guides the user to adjust the posture of the terminal to allow the ray to hit the object; and in response to the ray hitting the object, S212 is executed, and the terminal 104 presents an animation effect for the object to the user.

S210: the terminal 104 guides the user to adjust a posture of the terminal to allow the ray to hit the object.

The terminal 104 may guide the user to adjust the posture of the terminal 104 by drawing the screen display interface 106 to allow the ray to hit the object. As shown in FIG. 13, a display effect similar to simulated shooting may be displayed on the screen, to guide the user to adjust the posture of the terminal 104 so as to place the object in the central region of the screen display range. In this way, the terminal guides the user to adjust the posture, and then allows the ray to hit the object according to the adjustment on the posture of the terminal by the user.

S212: the terminal 104 presents an animation effect for the object to the user.

The terminal 104 may judge whether the object performs a next animation effect on the object through ray collision. The animation effect for the object may be a variety of animation effects, such as disappearance of the object.

For example, when the preset point is the central point of the screen, if the ray emitted based on this point hits the object, the terminal 104 may present to the user an animation effect that the object disappears. As shown in FIG. 13, a shooting picture is provided. In response to the object appearing within the center of the display interface 106, it may hit a monster for the user and present the animation effect that the monster disappears to the user, so as to improve the interest of the user in using it.

Based on the above description, embodiments of the present disclosure provides an object tracking method in an extended reality environment. The method is executed by the terminal 104. Specifically, the terminal 104 determines whether an object in the extended reality environment appears within the screen display range of the terminal 104; when the object does not appear within the screen display range, the terminal prompts the user of the orientation of the object to prompt the user to adjust the screen display range, and then a posture of the terminal 104 is adjusted according to an adjustment operation performed by the user, so that the object can appear within the screen display range of the terminal 104. In this way, the user does not need to rely on own experience to track the object, so that the difficulty of the user in tracking the object in the extended reality environment is reduced, and the user-friendliness and the interaction experience of the user are improved.

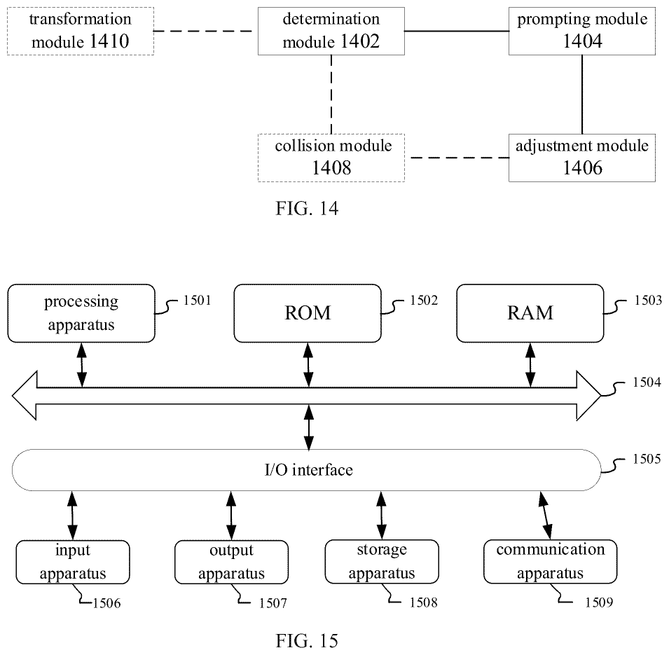

FIG. 14 is a schematic diagram of an object tracking apparatus in an extended reality environment according to an exemplary disclosed embodiment. As shown in FIG. 14, a behavior guiding apparatus 1400 includes:

a determination module 1402, configured to determine whether an object in the extended reality environment appears within a screen display range of the terminal;

a prompting module 1404, configured to prompt a user of an orientation of the object when the object does not appear within the screen display range of the terminal; and

an adjustment module 1406, configured to adjust a posture of the terminal to make the object to appear within the screen display range of the terminal, in response to an adjustment operation triggered by the user according to the orientation of the object, which is prompted.

Optionally, the apparatus further includes a collision module 1408, and the collision module 1408 may be configured to:
collide with the object based on a ray passing through the screen of the terminal in response to the object appearing within the screen display range of the terminal; and
present an animation effect for the object to the user in response to the ray hitting the object.

Optionally, the ray passes through the central point of the screen, and a direction of the ray is an orientation of a camera of the terminal.

Optionally, the prompting module 1404 may be configured to:
acquire a first transformation matrix from a camera coordinate system to a world coordinate system;
transform coordinates of the object in the world coordinate system into coordinates of the object in the camera coordinate system according to an inverse matrix of the first transformation matrix; and
determine an orientation of the object according to the coordinates of the object in the camera coordinate system.

Optionally, the orientation of the object is characterized by an azimuth angle, and the prompting module 1404 may be configured to:
determine a direction vector of the object according to the coordinates of the object in the camera coordinate system; and
determine the azimuth angle of the object according to the direction vector of the object.

Optionally, the prompting module 1404 may be configured to:
render a head up display (HUD) cue at a target position of the screen according to the azimuth angle of the object, the target position being a position corresponding to the azimuth angle of the object, and the HUD cue including the azimuth angle of the object.

Optionally, the determination module 1402 may be configured to:
determine whether the object appears within the screen display range of the terminal according to the coordinates of the object in the clipping coordinate system of the camera.

Optionally, the apparatus further includes a transformation module 1410, and the transformation module 1410 may be configured to:
acquire coordinates of the object in the world coordinate system; and
acquire coordinates of the object in the clipping coordinate system of the camera according to the coordinates of the object in the world coordinate system and a second transformation matrix.

The functions of the above-mentioned modules have been elaborated in the method steps in the previous embodiment, and are not described here again.

Referring to FIG. 15, FIG. 15 illustrates a schematic structural diagram of an electronic device 1500 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, a smart home device or the like. The electronic device illustrated in FIG. 1 is merely an example, and should not pose any limitation to the functions and the range of use of the embodiments of the present disclosure.

As illustrated in FIG. 15, the electronic device 1500 may include a processing apparatus 1501 (e.g., a central processing unit, a graphics processing unit, etc.), which can perform various suitable actions and processing according to a program stored in a read-only memory (ROM) 1502 or a program loaded from a storage apparatus 1508 into a random-access memory (RAM) 1503. The RAM 1503 further stores various programs and data required for operations of the electronic device 1500. The processing apparatus 1501, the ROM 1502, and the RAM 1503 are interconnected by means of a bus 1504. An input/output (I/O) interface 1505 is also connected to the bus 1504.

Usually, the following apparatus may be connected to the I/O interface 1505: an input apparatus 1506 including, for example, a touch screen, a touch pad, a keyboard, a mouse, a camera, a microphone, an accelerometer, a gyroscope, or the like; an output apparatus 1507 including, for example, a liquid crystal display (LCD), a loudspeaker, a vibrator, or the like; a storage apparatus 1508 including, for example, a magnetic tape, a hard disk, or the like; and a communication apparatus 1509. The communication apparatus 1509 may allow the electronic device 1500 to be in wireless or wired communication with other devices to exchange data. While FIG. 15 illustrates the electronic device 1500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 1509 and installed, or may be installed from the storage apparatus 1508, or may be installed from the ROM 1502. When the computer program is executed by the processing apparatus 1501, the above-mentioned functions defined in the method of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus, or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate, or transmit a program used by or in combination with an instruction execution system, apparatus, or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: determine whether the object in the extended reality environment appears within a screen display range of the terminal; prompt a user of an orientation of the object when the object does not appear within the screen display range of the terminal; and adjust a posture of the terminal to make the object to appear within the screen display range of the terminal, in response to an adjustment operation triggered by the user according to the orientation of the object, which is prompted. The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus, or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example 1 provides an object tracking method in an extended reality environment, being applied to a terminal, the method including: determining whether the object in the extended reality environment appears within a screen display range of the terminal; prompting a user of an orientation of the object when the object does not appear within the screen display range of the terminal; and adjusting a posture of the terminal to make the object to appear within the screen display range of the terminal, in response to an adjustment operation triggered by the user according to the orientation of the object, which is prompted.

According to one or more embodiments of the present disclosure, Example 2 provides the method of Example 1, the method further includes: colliding with the object based on a ray passing through the screen of the terminal in response to the object appearing within the screen display range of the terminal; and presenting an animation effect for the object to the user in response to the ray hitting the object.

According to one or more embodiments of the present disclosure, Example 3 provides the method of Example 3, wherein the ray passes through a central point of the screen, and a direction of the ray is an orientation of a camera of the terminal.

According to one or more embodiments of the present disclosure, Example 4 provides the method of Example 1, wherein when the object does not appear within the screen display range of the terminal, the method further includes: acquiring a first transformation matrix from a camera coordinate system to a world coordinate system; transforming coordinates of the object in the world coordinate system into coordinates of the object in the camera coordinate system according to an inverse matrix of the first transformation matrix; and determining the orientation of the object according to the coordinates of the object in the camera coordinate system.

According to one or more embodiments of the present disclosure, Example 5 provides the method of Example 4, wherein the orientation of the object is characterized by an azimuth angle, and the determining the orientation of the object according to the coordinates of the object in the camera coordinate system includes: determining a direction vector of the object according to the coordinates of the object in the camera coordinate system; and determining the azimuth angle of the object according to the direction vector of the object.

According to one or more embodiments of the present disclosure, Example 6 provides the method of Example 5, wherein the prompting the user of the orientation of the object includes: rendering a head up display (HUD) cue at a target position of the screen according to the azimuth angle of the object, the target position being a position corresponding to the azimuth angle of the object, and the HUD cue including the azimuth angle of the object.

According to one or more embodiments of the present disclosure, Example 7 provides any one of methods of Examples 1-6, wherein the determining whether the object in the extended reality environment appears within the screen display range of the terminal includes: determining whether the object appears within the screen display range of the terminal according to coordinates of the object in a clipping coordinate system of a camera.

According to one or more embodiments of the present disclosure, Example 8 provides the method of Example 7, the method further includes: acquiring coordinates of the object in a world coordinate system; and acquiring coordinates of the object in a clipping coordinate system of the camera according to the coordinates of the object in the world coordinate system and a second transformation matrix.

According to one or more embodiments of the present disclosure, Example 9 provides an object tracking apparatus in an extended reality environment, including: a determination module, configured to determine whether an object in the extended reality environment appears within a screen display range of the terminal; a prompting module, configured to prompt a user of an orientation of the object when the object does not appear within the screen display range of the terminal; and an adjustment module, configured to adjust a posture of the terminal to make the object to appear within the screen display range of the terminal, in response to an adjustment operation triggered by the user according to the orientation of the object, which is prompted.

According to one or more embodiments of the present disclosure, Example 10 provides the apparatus of Example 9, the apparatus further includes a collision module used for colliding with the object based on a ray passing through the screen of the terminal in response to the object appearing within the screen display range of the terminal; and presenting an animation effect for the object to the user in response to the ray hitting the object.

According to one or more embodiments of the present disclosure, Example 11 provides the apparatus of Example 10, wherein the ray passes through a central point of the screen, and a direction of the ray is an orientation of a camera of the terminal.

According to one or more embodiments of the present disclosure, Example 12 provides the apparatus of Example 9, wherein the prompting module is used for acquiring a first transformation matrix from a camera coordinate system to a world coordinate system; transforming coordinates of the object in the world coordinate system into coordinates of the object in the camera coordinate system according to an inverse matrix of the first transformation matrix; and determining the orientation of the object according to the coordinates of the object in the camera coordinate system.

According to one or more embodiments of the present disclosure, Example 13 provides the apparatus of Example 12, wherein the prompting module is used for determining a direction vector of the object according to the coordinates of the object in the camera coordinate system; and determining the azimuth angle of the object according to the direction vector of the object.

According to one or more embodiments of the present disclosure, Example 14 provides the apparatus of Example 13, wherein the prompting module is used for rendering a head up display (HUD) cue at a target position of the screen according to the azimuth angle of the object, the target position being a position corresponding to the azimuth angle of the object, and the HUD cue including the azimuth angle of the object.

According to one or more embodiments of the present disclosure, Example 15 provides any one of apparatus of Examples 1-6, wherein the determination module is used for determining whether the object appears within the screen display range of the terminal according to coordinates of the object in a clipping coordinate system of a camera.

According to one or more embodiments of the present disclosure, Example 16 provides the apparatus of Example 15, wherein a transformation module is used for acquiring coordinates of the object in a world coordinate system; and acquiring coordinates of the object in a clipping coordinate system of the camera according to the coordinates of the object in the world coordinate system and a second transformation matrix.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims. With respect to the apparatus in the above-mentioned embodiment, the specific manner in which each module performs the operation has been described in detail in the embodiments related to the method, and will not be described in detail here.

1. An object tracking method in an extended reality environment, being applied to a terminal, the method comprising:
determining whether an object in the extended reality environment appears within a screen display range of the terminal;
prompting a user of an orientation of the object when the object does not appear within the screen display range of the terminal; and
adjusting a posture of the terminal to make the object to appear within the screen display range of the terminal, in response to an adjustment operation triggered by the user according to the orientation of the object, which is prompted.

2. The method according to claim 1, further comprising:
colliding with the object based on a ray passing through the screen of the terminal in response to the object appearing within the screen display range of the terminal; and
presenting an animation effect for the object to the user in response to the ray hitting the object.

3. The method according to claim 2, wherein the ray passes through a central point of the screen, and a direction of the ray is an orientation of a camera of the terminal.

4. The method according to claim 1, wherein before the prompting the user of the orientation of the object when the object does not appear within the screen display range of the terminal, the method further comprises:
acquiring a first transformation matrix from a camera coordinate system to a world coordinate system;
transforming coordinates of the object in the world coordinate system into coordinates of the object in the camera coordinate system according to an inverse matrix of the first transformation matrix; and
determining the orientation of the object according to the coordinates of the object in the camera coordinate system.

5. The method according to claim 4, wherein the orientation of the object is characterized by an azimuth angle, and the determining the orientation of the object according to the coordinates of the object in the camera coordinate system comprises:
determining a direction vector of the object according to the coordinates of the object in the camera coordinate system; and
determining the azimuth angle of the object according to the direction vector of the object.

6. The method according to claim 5, wherein the prompting the user of the orientation of the object comprises:
rendering a head up display (HUD) cue at a target position of the screen according to the azimuth angle of the object, the target position being a position corresponding to the azimuth angle of the object, and the HUD cue comprising the azimuth angle of the object.

7. The method according to claim 1, wherein the determining whether the object in the extended reality environment appears within the screen display range of the terminal comprises:
determining whether the object appears within the screen display range of the terminal according to coordinates of the object in a clipping coordinate system of a camera.

8. The method according to claim 7, further comprising:
acquiring coordinates of the object in a world coordinate system; and
acquiring coordinates of the object in a clipping coordinate system of the camera according to the coordinates of the object in the world coordinate system and a second transformation matrix.

9. An object tracking apparatus in an extended reality environment, comprising:
a determination module, configured to determine whether an object in the extended reality environment appears within a screen display range of the terminal;
a prompting module, configured to prompt a user of an orientation of the object when the object does not appear within the screen display range of the terminal; and
an adjustment module, configured to adjust a posture of the terminal to make the object to appear within the screen display range of the terminal, in response to an adjustment operation triggered by the user according to the orientation of the object, which is prompted.

10. An electronic device, comprising:
a storage apparatus, having stored thereon a computer program;
a processing apparatus, configured to execute the computer program in the storage apparatus to implement steps of the method according to claim 1.

11. A computer-readable storage medium, having stored thereon a computer program, the computer program, when executed by a processing apparatus, implementing steps of the method according to claim 1.

12. (canceled)

13. The apparatus according to claim 9, further includes a collision module, which is configured to:
collide with the object based on a ray passing through the screen of the terminal in response to the object appearing within the screen display range of the terminal; and
present an animation effect for the object to the user in response to the ray hitting the object.

14. The apparatus according to claim 13, wherein the ray passes through the central point of the screen, and a direction of the ray is an orientation of a camera of the terminal.

15. The apparatus according to claim 9, wherein the prompting module is configured to:
acquire a first transformation matrix from a camera coordinate system to a world coordinate system;
transform coordinates of the object in the world coordinate system into coordinates of the object in the camera coordinate system according to an inverse matrix of the first transformation matrix; and
determine the orientation of the object according to the coordinates of the object in the camera coordinate system.

16. The apparatus according to claim 15, wherein the orientation of the object is characterized by an azimuth angle, and the prompting module is configured to:
determine a direction vector of the object according to the coordinates of the object in the camera coordinate system; and
determine the azimuth angle of the object according to the direction vector of the object.

17. The apparatus according to claim 16, wherein the prompting module is configured to:
render a head up display (HUD) cue at a target position of the screen according to the azimuth angle of the object, the target position being a position corresponding to the azimuth angle of the object, and the HUD cue including the azimuth angle of the object.

18. The apparatus according to claim 9, wherein the determination module is configured to:
determine whether the object appears within the screen display range of the terminal according to the coordinates of the object in the clipping coordinate system of the camera.

19. The apparatus according to claim 18, further comprising:
a transformation module, configured to acquire coordinates of the object in the world coordinate system; and
acquire coordinates of the object in the clipping coordinate system of the camera according to the coordinates of the object in the world coordinate system and a second transformation matrix.
